(19) United States
(12) Patent Application Publication
(10) Pub. No.: US 2020/0405450 A1
(43) Pub. Date: Dec. 31, 2020

(54) DENTAL MULTI-VECTORIAL ANCHORAGE

(71) Applicant: Esma KURIS BASTAN, Istanbul (TR)

(72) Inventor: Esma KURIS BASTAN, Istanbul (TR)

(21) Appl. No.: 16/978,787

(22) PCT Filed: Feb. 4, 2019
(86) PCT No.: PCT/TR2019/050065

§ 371 Date: Sep. 8, 2020

(30) Foreign Application Priority Data
Mar. 8, 2018 (TR) 2018/03316

(51) Int. Cl. A61C 7/14; A61C 8/00

(52) U.S. Cl. CPC A61C 7/14; A61C 8/008; A61C 8/0096

(57) ABSTRACT

The invention relates to mini plates and anchorages which are used in orthodontics in dentistry and which can be used in the field of oral and maxillofacial surgery. The invention has plate socket arms with the threaded plate sockets on which the plates are fixed in the form shown in FIG. 1, and under these plate socket arms, screw sockets fixed with the multi-vectorial anchorage unit fixation of the detachable multi-vectorial anchorage unit as shown in FIG. 2. Detachable multi-vectorial anchorage units and threaded healing screws can be fixed on said screw sockets by clamping these threads.

### CROSS REFERENCE TO THE RELATED APPLICATIONS

This application is the national phase entry of International Application No. PCT/TR2019/050065, filed on Feb. 4, 2019, which is based upon and claims priority to Turkish Patent Application No. 2018/03316, filed on Mar. 8, 2018, the entire contents of which are incorporated herein by reference.

### TECHNICAL FIELD

The invention relates to mini plates and anchorages which are used in orthodontics in dentistry and which can be used in the field of oral and maxillofacial surgery.

### BACKGROUND

Anchorage is one of the biggest problems of orthodontics. The reason for this is that the application of orthodontic force result with displacement of the teeth taken as an anchorage, where movement is not desired. Failure to maintain the anchorage well during treatment may result in undesirable and uncontrollable occlusion and poor treatment. For this reason, modern orthodontics is in search for new devices for the cases of absolute anchorage.

Skeletal anchorage systems have been proposed to solve this problem. Skeletal anchorage is successfully used in intrusion of buccal segments, skeletal open bite cases, lifting and intrusion of molars, closure of cavities, eruption of buried teeth, management of growth of jaws and in compensation treatment of cases requiring orthognathic surgery. Systems used as skeletal anchorage are generally mini screws, mini plates, palatal implants and dental implants. The multi-vectorial anchorage system designed in the present invention is a mini plate system with improved new features.

The biggest advantage of the mini plates compared to mini screws used for similar purposes is that they are the systems with lowest failure ratio. Mini plates provide the best stability among the skeletal anchorage systems. The mean failure raters were 7.3% for mini plates, 10.5% for palatal implants and 16.4% for mini screws. The ease of use and inexpensiveness of the mini screws increase their popularity. However, they are usually placed between the roots and this prevent the desired tooth movements and they cause soft tissue irritations in the attachment are with a possibility of damaging the dental roots during the application. Additionally, it is possible that the mini screws easily loosen their connection with the bone during the force, and cause damage to the important anatomical neighborhood by erupting into the bone with the application of force during the displacement of the teeth. Although it is suggested by researchers that the anchorage should be placed in safe areas away from important vascular and nerve structures in toothless areas, the anatomical formations where anchoring is necessary do not always allow this recommendation to be followed. The need for different force vectors changing with tooth movement is only possible by removing the mini screws from the bone and re-inserted them. Mini plates can be placed anywhere in the mouth with dentoalveolar and basal bone and can perform many dental movements without requiring any other surgical procedures. The long-term use of mini plates has been proven to be stable and biocompatible. Many studies in the literature determined that mini plates increased the amount of movement with their application to areas far enough that they will not prevent the movement of the teeth. Additionally, the insertion and removal of mini plates were stated to be minimally invasive and it was reported that they had moderate postoperative discomfort and very little risk.

Mini plates attracted the attention of clinicians because of all these advantages, and they have find application in various shapes and sizes in recent years. Various changes and modifications on the dimensions and shapes of mini plates are presented in the literature. With all these modifications, the disadvantages of conventional mini plates have been tried to be improved. The greatest insufficiency of the systems offered today leads to the loss of the stability of the mini plates by the part of the mini plates coming from the oral mucous causing soft tissue inflammation, which directly affects the outcome of orthodontic treatment. A second disadvantage is that the direction and amount of force applied to the teeth from the mini plate must be changed as a result of the movement of the teeth, but by changing the direction and amount of the force with these systems is only possible with the replacement of the mini plates with a second surgical procedure. In some studies of the literature, bendable oral parts have been presented as solutions, however, this could not meet the needs due to the high risk of breakage of the bended places and the possible material fatigue, the fact that the bending can occur only once, and the fact that following the bending, it can cause mucosal injuries and inflammation, therefore leading to the loss of the mini plates. Moreover, it is not comfortable for the patient due to both the force applied and the mucosal injuries during the bending.

### SUMMARY

The present invention relates to a dental multi-vectorial anchorage to eliminate the aforementioned disadvantages and provide new advantages to the relevant technical field.

An advantage of the invention is that the mini plates have gum healing screw and removable superstructure abutment parts that have never been applied before. The most important drawback of the traditional mini plates is that they cause tissue irritation in the area opening to the mouth and the mucosa and cause infection in this area and lead to premature removal of the mini plate. Shaping of this area with the healing screws and attaching the superstructure to be applied force create great advantage. Furthermore, it is an important feature that these superstructure parts can be positioned at 8 different angles around their own axis and that they can move so as to change the force application zone on the plate.

### BRIEF DESCRIPTION OF THE DRAWINGS

Embodiments of the present invention briefly summarized above and discussed in more detail below can be understood by reference to the exemplary embodiments described in the accompanying drawings. It should be noted, however, that the accompanying drawings only illustrate the typical structures of the present invention and therefore, they will are not intended to limit the scope of the invention, since it may allow other equally effective structures.

Identical reference numbers are used where possible to identify identical elements common in the figures to facilitate understanding. The figures are not drawn with a scale and can be simplified for clarity. It is contemplated that the elements and features of an embodiment may be usefully incorporated into other embodiments without further explanation.

FIG. 1 is a perspective view of a detachable multi-vectorial anchorage application in the mini plate.

FIG. 2 is a view showing the screw socket of the invention.

FIG. 3 is a perspective view of the healing screw application of the invention.

FIG. 4 is a top view of the multi-vectorial anchorage application of the invention.

FIG. 5 is a view with the screw socket of the invention is empty.

FIG. 6 is a cross-sectional view applied healing screw of the invention.

FIG. 7 is a general and top view of the fixation screw applied to the multi-vectorial anchorage of the invention.

FIG. 8 is a view of the implant fixation screw applied to the multi-vectorial anchorage of the invention.

FIG. 9 is a view of the healing intermediate screw applied to the multi-vectorial anchorage of the invention.

The equivalents of the reference codes shown in the figures are provided below.
1 Detachable multi-vectorial anchorage unit,
2 Plate socket,
3 Screw socket,
4 Plate socket arm,
5 Healing screw,
6 Multi-vectorial anchorage unit fixation,
7 Mini screw
7a Mini screw socket,
7b Supra mukosa,
7c Trans mucosa,
7d Neck,
7e Body,
7f Screw blades,
7g Locked apex,
8 Implant fixation screw,
9 Healing intermediate screw.

### DETAILED DESCRIPTION OF THE EMBODIMENTS

In this detailed description, preferred alternatives of the dental multi-vectorial anchorage embodiment of the invention are described only for a better understanding of the subject and without any limiting effect.

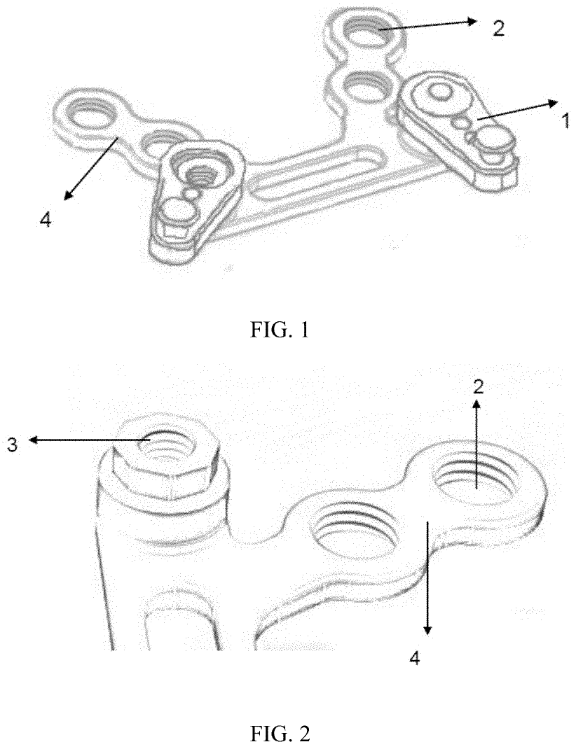

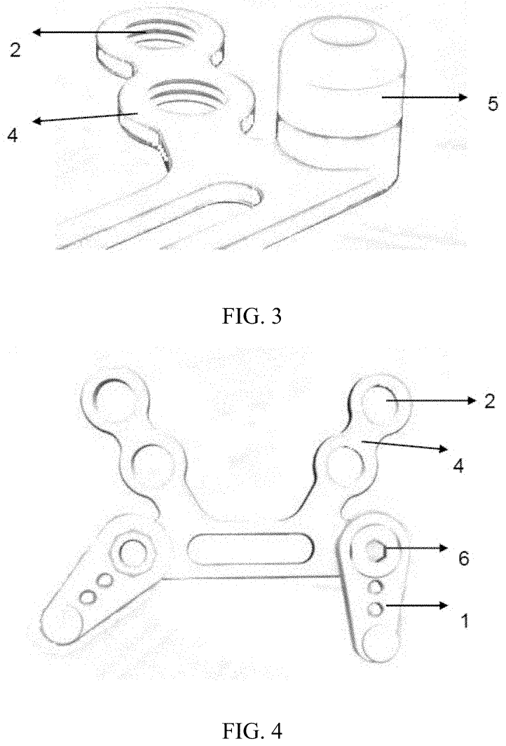

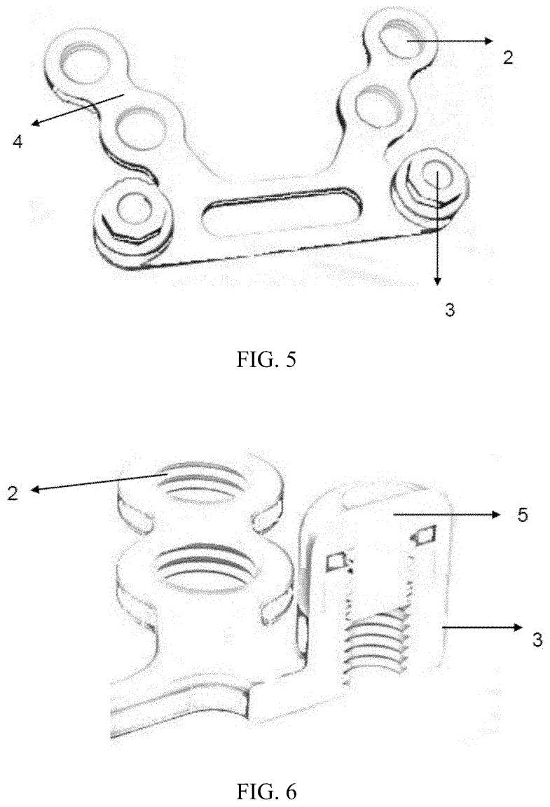

The invention has plate socket arms (4) with the threaded plate sockets (2) on which the plates are fixed in the form shown in FIG. 1, and under these plate socket arms (4), screw sockets (3) fixed with the multi-vectorial anchorage unit fixation (6) of the detachable multi-vectorial anchorage unit (1) as shown in FIG. 2. Detachable multi-vectorial anchorage units (1) and threaded healing screws (5) can be fixed on said screw sockets (3) by clamping these threads.

In the mini-plate of the invention, the detachable multi-vectorial anchorage units (1) provide the possibility of being applied to the oral region at an angle of 360° during the operation. After this application, they are fixed with multi-vectorial anchorage unit fixation (6). In the invention, the oral mucosa is sutured after the application of the mini plate to the bone and the healing screws (5) are inserted to the screw sockets (3) to provide healing of the tissues, and the following the healing, healing screws (5) are removed and replaced with the detachable multi-vectorial anchorage units (1). These detachable multi-vectorial anchorage units (1) act as braces and hang and attach the application apparatus.

Following the insertion of the mini plates into the bone and suturing the oral mucosa, the surrounding tissue is healed with healing screws (5) and the healing screws (5) are easily removed from the fully healed gum free of tissue irritation and the superstructure abutment parts in the desired shape and modification can be easily placed to the patient without causing any pain. These abutment parts are designed to be in various sizes and shapes for hanging or attachment of the apparatus to apply force.

The detachable multi-vectorial anchorage unit (1) shown in the drawings can also be arranged in different ways with the bracket-headed parts having sockets in which orthodontic wires can be placed. At the same time, the shape of the mini plate and the number of plate sockets (2) to which the fixation screw will fit can be produced in different shapes and sizes to facilitate the anatomical regions to be applied.

The same superstructure systems are planned to be implemented on the mini screws, which are a kind of skeletal anchorage. Following the insertion of mini screws in the bone and the insertion of the healing heads (5) and following the healing of the tissue, the detachable multi-vectorial anchorage units (1) can be placed in the desired size and angle of the dentist.

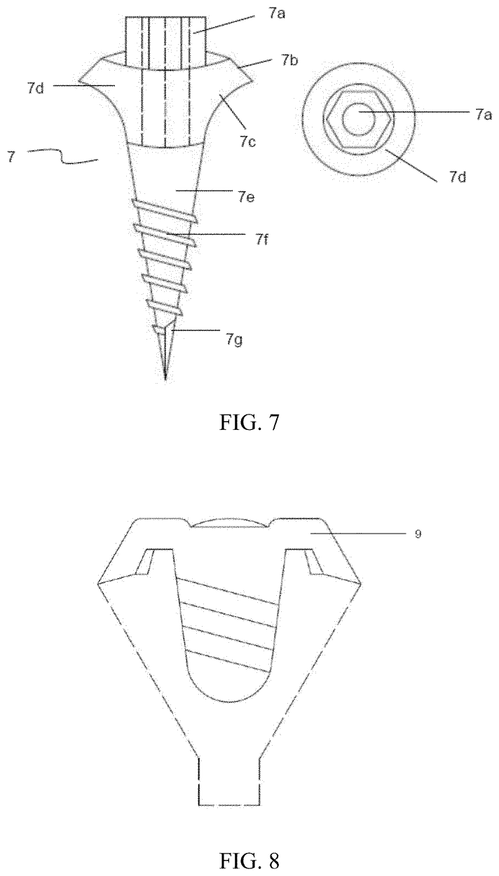

In the invention, a mini screw (7) can be applied in the detachable multi-vectorial anchorage units (1) as seen in FIG. 7. On the upper side of this mini screw (7) there is a mini screw socket (7a) which is in a uniform state with the mini screw (7). A screw is attached to said mini screw socket (7a) that secures the detachable multi-vectorial anchorage unit (1). The neck (7d) of the mini screw (7) consists of the trans mucosa (7c) which is the portion corresponding to the supra mucosa (7b) on the gum and the alveolar mucosal thickness on the bone. Twin screw blades (7f) are provided on the body (7e) of the mini screw (7), which are also known as the alveoli in the bone. At the far end of the body (7e), a locked apex (7g) is provided to increase the stability of the bone and to increase the integration surface between the bone and the mini screw. The dimensions of the mini screw (7) may vary depending on the use.

In the invention, as seen in FIG. 8, the healing intermediate screw (9) which is inserted after the placement of the mini screw (7) in FIG. 7 and which provides the gum shaping and prevents inflammation can be applied.

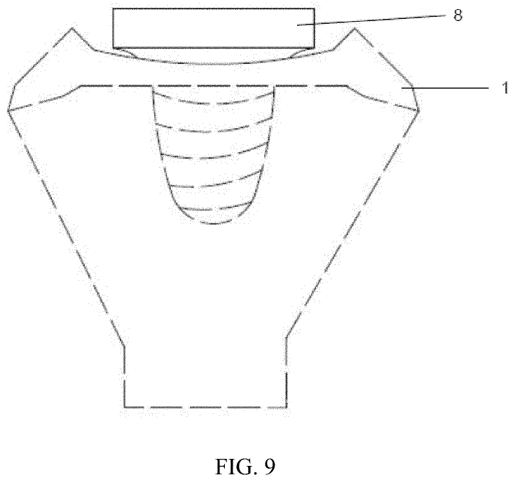

In the invention, an implant fixation screw (8) can be applied in the detachable multi-vectorial anchorage units (1) as can be seen in FIG. 9.

What is claimed is:

1. A dental mini plate, comprising:
a detachable multi-vectorial anchorage unit;
a plate socket;
a screw socket;
a plate socket arm;
a healing screw; and
a multi-vectorial anchorage unit fixation;
wherein the plate socket arm comprises at least one plate socket under the plate socket arm, the screw socket are fixed with the multi-vectorial anchorage unit fixation of the detachable multi-vectorial anchorage unit, and the detachable multi-vectorial anchorage unit and the healing screw with threads can be fixed on the screw socket by clamping the threads.

2. The dental mini plate of claim 1, wherein an oral mucosa is sutured after the dental mini plate is applied to a bone and the healing screw is inserted to the screw socket to provide healing of tissues, and following the healing of the tissues, the healing screw is removed and replaced with the detachable multi-vectorial anchorage unit, wherein the detachable multi-vectorial anchorage unit is acting as braces for hanging and attaching the dental mini plate to an oral region.

3. The dental mini plate of claim 1, wherein the detachable multi-vectorial anchorage unit is configured to be arranged in different shapes, and the detachable multi-vectorial anchorage unit comprises bracket-headed parts having sockets, wherein the sockets are configured for receiving orthodontic wires; and a fixation screw fits in a shape of the dental mini plate and a number of the plate socket, and the fixation screw is produced in different shapes and sizes to facilitate an application of the dental mini plate to different anatomical regions.

4. A multi-vectorial anchorage unit, wherein the multi-vectorial anchorage unit is used as the detachable multi-vectorial anchorage unit of the dental mini plate of claim 1, and the multi-vectorial anchorage unit is positioned at 8 different angles around an axis of the multi-vectorial anchorage unit with 360 degrees and moves so as to change a force application zone on the dental mini plate.

5. The multi-vectorial anchorage unit of claim 4, wherein a mini screw and an implant fixation screw is applied to the dental mini plate.

6. A mini screw, wherein the mini screw is applied to the dental mini plate of claim 1, the mini screw is in different sizes according to use, wherein the dental mini plate has a mini screw socket and the mini screw socket is in an uniform state with a mini screw, the mini screw is attached to the mini screw socket to secure the detachable multi-vectorial anchorage unit; a neck of the mini screw comprises a trans mucosa corresponding to a supra mucosa (7b) on the gum and an alveolar mucosal thickness on a bone; twin screw blades are provided on a body of the mini screw, and the twin screw blades of the mini screw are also known as alveoli in the bone; at a far end of the body of the mini screw, a locked apex is provided to increase a stability of the bone and to increase an integration surface between the bone and the mini screw.

7. The mini screw of claim 6, wherein a healing intermediate screw is inserted after a placement of the mini screw to provide a gum shaping and prevent inflammation.

8. The dental mini plate of claim 2, wherein the detachable multi-vectorial anchorage unit is configured to be arranged in different shapes, and the detachable multi-vectorial anchorage unit comprises bracket-headed parts having sockets, wherein the sockets are configured for receiving orthodontic wires; and a fixation screw fits in a shape of the dental mini plate and a number of the plate socket, and the fixation screw is produced in different shapes and sizes to facilitate an application of the dental mini plate to different anatomical regions.

9. The multi-vectorial anchorage unit of claim 4, wherein an oral mucosa is sutured after the dental mini plate is applied to a bone and the healing screws is inserted to the screw socket to provide healing of tissues, and following the healing of the tissues, the healing screw is removed and replaced with the detachable multi-vectorial anchorage unit, wherein the detachable multi-vectorial anchorage unit is acting as braces for hanging and attaching the dental mini plate to an oral region.

10. The multi-vectorial anchorage unit of claim 4, wherein the detachable multi-vectorial anchorage unit is configured to be arranged in different shapes, and the detachable multi-vectorial anchorage unit comprises bracket-headed parts having sockets, wherein the sockets are configured for receiving orthodontic wires; and a fixation screw fits in a shape of the dental mini plate and a number of the plate socket, and the fixation screw is produced in different shapes and sizes to facilitate an application of the dental mini plate to different anatomical regions.

11. The mini screw of claim 6, wherein an oral mucosa is sutured after the dental mini plate is applied to a bone and the healing screws is inserted to the screw socket to provide healing of tissues, and following the healing of the tissues, the healing screw is removed and replaced with the detachable multi-vectorial anchorage unit, wherein the detachable multi-vectorial anchorage unit is acting as braces for hanging and attaching the dental mini plate to an oral region.

12. The mini screw of claim 6, wherein the detachable multi-vectorial anchorage unit is configured to be arranged in different shapes, and the detachable multi-vectorial anchorage unit comprises bracket-headed parts having sockets, wherein the sockets are configured for receiving orthodontic wires; and a fixation screw fits in a shape of the dental mini plate and a number of the plate socket, and the fixation screw is produced in different shapes and sizes to facilitate an application of the dental mini plate to different anatomical regions.
